(19) United States
(12) Patent Application Publication
(10) Pub. No.: US 2015/0020009 A1
(43) Pub. Date: Jan. 15, 2015

(54) Joystick Controller Swipe Method

(71) Applicant: Keane and Able Limited, Dublin (IE)

(72) Inventor: Anthony Keane, Dublin (IE)

(21) Appl. No.: 14/298,839

(22) Filed: Jun. 6, 2014

Related U.S. Application Data
(60) Provisional application No. 61/832,245, filed on Jun. 7, 2013.

(51) Int. Cl. G06F 3/01; G06F 3/0484; G06F 3/0488; G06F 3/0481

(52) U.S. Cl. CPC G06F 3/017; G06F 3/0481; G06F 3/04847; G06F 3/0488
USPC 715/765

(57) ABSTRACT

The invention is directed toward a computer system and method for scrolling through a multiple number of display panels on the touch screen of an electronic device. The invention is directed toward a computer system and method to detect a tap on the touch screen interface within a predetermined area on the touch screen interface, detect a swipe gesture across the touch screen interface, perform a predetermined function changing the visual display output of the touch screen interface when the swipe gesture exceeds the boundaries of the predetermined area, and change the visual display output of the touch screen interface by moving a plurality of display panels across the touch screen interface in an opposite direction than the direction of the swipe gesture. The swipe gesture comprises an initial touchdown point within the predetermined area and a direction, and terminates outside of the predetermined area.

### PRIORITY

This application claims priority to U.S. Provisional Patent Application No. 61/832,245 which is hereby incorporated by reference in its entirety.

### FIELD OF THE INVENTION

The invention relates generally to a graphical user interface and more specifically to a computer implemented software and system for scrolling between multiple screens on the display of a touch screen device.

### BACKGROUND OF THE INVENTION

Touch screen user interface is in prolific use on a plethora of handheld computing devices, including cellular phones and tablets. A user can interact with software by touching and dragging his finger on a touch screen of any of these electronic devices. A user can move through different screens on a handheld device. Each screen displays different information to a user, such as a different application, a different home screen with different icons, or any other information which may be displayed. A user can flip through these different screen displays by dragging a finger across the screen of the device.

As an example of how this has been done historically follows. If a user desires to flip to a screen which exists to the left of the current screen the user is on then the user will do the following steps: (1) the user touches his finger to the screen on the left side of the screen (2) the user drags his finger from left to right across the screen of the device. While doing this the current screen follows the user's finger from left to right and slides out of view of the display screen. The desired screen comes into view from the left to the right and ends in full view on the display.

This method is limited in that a user can only move one screen at a time and must repeat the process to move through multiple screens. If a user has multiple screens open on a device, or multiple applications running, at any one time, the process of switching between screens and applications becomes a tedious and inefficient process. The user must touch and swipe the screen multiple times to get to the desired location. What is needed is a method for a user to scroll through multiple screens with one swiping move.

### SUMMARY OF THE INVENTION

The invention is directed toward a computer system and method for scrolling through a multiple number of display panels on the touch screen of an electronic device. The invention is directed toward a computer system having a processor operatively coupled to a memory and a touch screen interface, the computer system being adapted to detect a tap on the touch screen interface within a predetermined area on the touch screen interface, detect a swipe gesture across the touch screen interface, perform a predetermined function changing the visual display output of the touch screen interface when the swipe gesture exceeds the boundaries of the predetermined area, and change the visual display output of the touch screen interface by moving a plurality of display panels across the touch screen interface in an opposite direction than the direction of the swipe gesture. The swipe gesture comprises an initial touchdown point within the predetermined area and a direction, and terminates outside of the predetermined area. Additionally the computer system may be adapted to present a graphical image within the predetermined area on the touch screen interface, present the graphical image on the touch screen interface during the swipe gesture, and present the graphical image along the path of the swipe gesture substantially simultaneous with the swipe gesture. The computer system may be a tablet computer or a mobile telephone.

The invention is also directed toward a non-transitory computer readable storage medium storing one or more programs, the one or more programs comprising instructions, which when executed by an electronic device, the electronic device comprising a touch screen interface in which taps of a touch object generate a change in the visual display output of the electronic device, cause the electronic device to detect a tap on the touch screen interface within a predetermined area on the touch screen interface, detect a swipe gesture across the touch screen interface, perform a function changing the visual display output of the touch screen interface when the swipe gesture exceeds the boundaries of the predetermined area, and change the visual display output of the touch screen interface by moving a plurality of display panels across the touch screen interface in an opposite direction than the direction of the swipe gesture. The swipe gesture comprises an initial touchdown point within the predetermined area and a direction and terminates outside of the predetermined area. Additionally the computer readable storage medium may have instructions to present a graphical image within the predetermined area on the touch screen interface, present the graphical image on the touch screen interface during the swipe gesture, and present the graphical image along the path of the swipe gesture substantially simultaneous with the swipe gesture. The electronic device may be a tablet computer or a mobile telephone.

The invention is also directed toward a method utilized on a computer system having a processor operatively coupled to a memory and a touch screen display. The method comprises detecting a tap on the touch screen interface within a predetermined area on the touch screen interface, detecting a swipe gesture across the touch screen interface, performing a function changing the visual display output of the touch screen interface when the swipe gesture exceeds the boundaries of the predetermined area, and changing the visual display output of the touch screen interface by moving a plurality of display panels across the touch screen interface in an opposite direction than the direction of the swipe gesture. The swipe gesture comprises an initial touchdown point within the predetermined area and a direction and terminates outside of the predetermined area.

The method may further comprise presenting a graphical image within the predetermined area on the touch screen interface, presenting the graphical image on the touch screen interface during the swipe gesture, and presenting the graphical image along the path of the swipe gesture substantially simultaneous with the swipe gesture. Additionally, the method may further comprise detecting the distance of the swipe from the predetermined area and moving the plurality of display panels across the touch screen interface in a ratio proportionate to the distance of the swipe from the predetermined area. The computer system in the method may be a tablet computer or a mobile telephone.

### BRIEF DESCRIPTION OF THE DRAWINGS

FIG. 1 is a view of a touch interface screen utilizing the invention.

FIG. 2 is a view of a touch interface screen utilizing the invention.

FIG. 3 is a view of a touch interface screen utilizing the invention.

FIG. 4 is a view of a touch interface screen utilizing the invention.

FIG. 5 is a view of a device with a touch interface screen utilizing the invention.

FIG. 6 is a view of a device with a touch interface screen utilizing the invention.

FIG. 7 is a view of a device with a touch interface screen utilizing the invention.

FIG. 8 is a view of a device with a touch interface screen utilizing the invention.

FIG. 9 is a view of a device with a touch interface screen utilizing the invention.

FIG. 10 is a view of a device with a touch interface screen utilizing the invention.

FIG. 11 is a schematic view of a basic electronic device utilizing the invention.

FIG. 12 is a schematic view of the method of utilizing the invention.

### DETAILED DESCRIPTION OF THE DRAWINGS

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface device”, or the like are generally intended to refer to a computer-related entity, either hardware, a combination of hardware and software, software, or software in execution. For example, a component may be, but is not limited to being, a method, an object, an executable, a thread of execution, a program, and/or a computer. By way of illustration, both an application running on a controller and the controller can be a component.

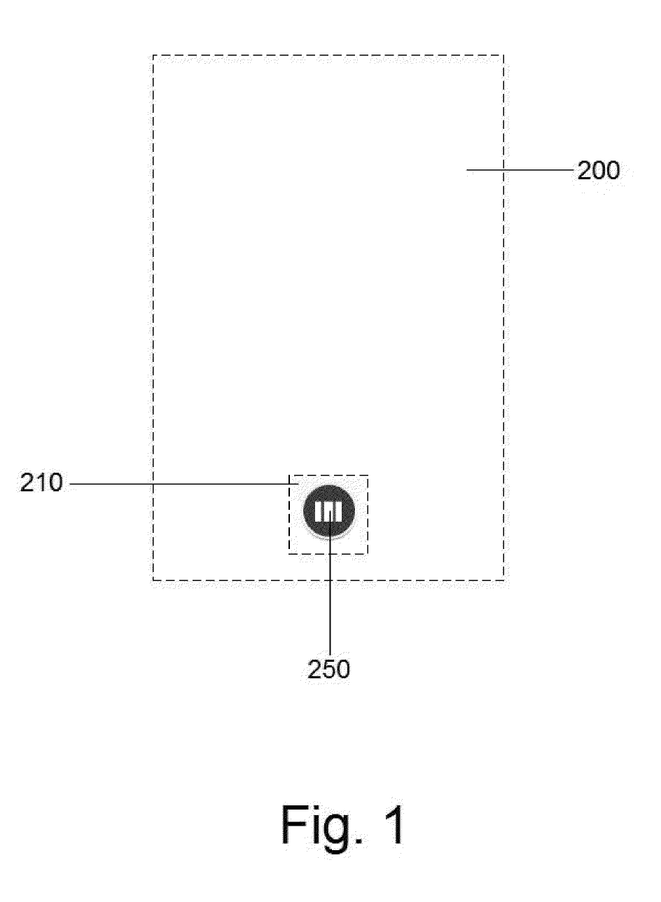

Referring to FIG. 1, a view of a touch screen interface 200 is displayed. Within the touch screen interface 200 is a predetermined area 250. The predetermined area 210 is receptive to an initial tap by a user for the purpose of changing the panel displayed on the touch screen interface 200. The predetermined area 210 may of any size and shape provided that the predetermined area 210 is smaller than the total area of the touch screen interface 200 so that way there is a space on the touch screen interface 200 which is within the predetermined area 210 and a space on the touch screen interface 200 which is outside of the predetermined area 210. In the preferred embodiment, a graphical image 250 is displayed within the predetermined area 210. In other embodiments, the system of tapping and swiping the touch screen interface 200 may be performed without a graphical image 250. The graphical image 250 may be any size, shape, and color.

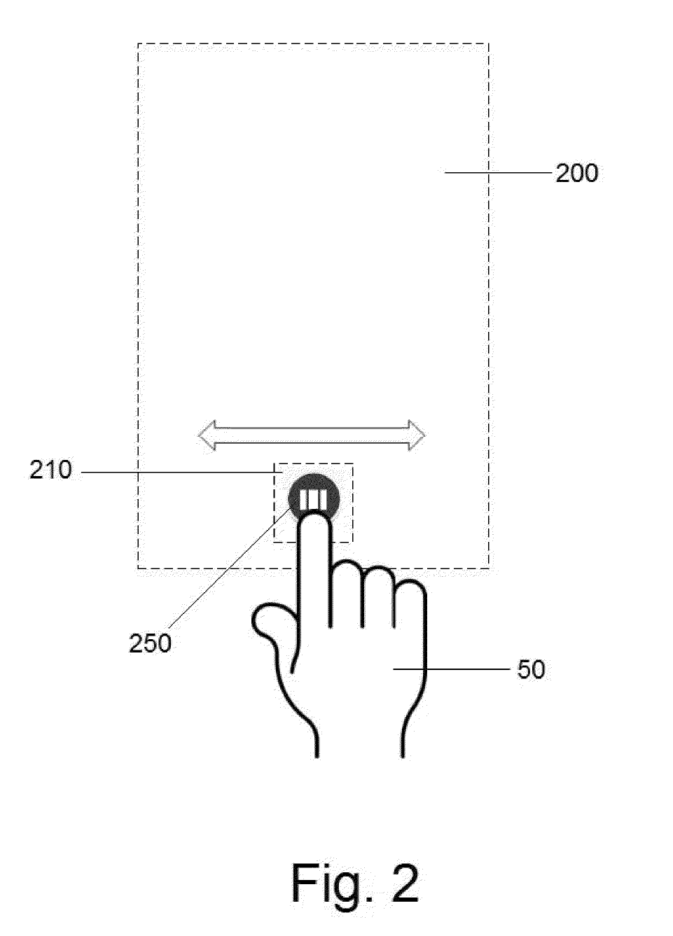

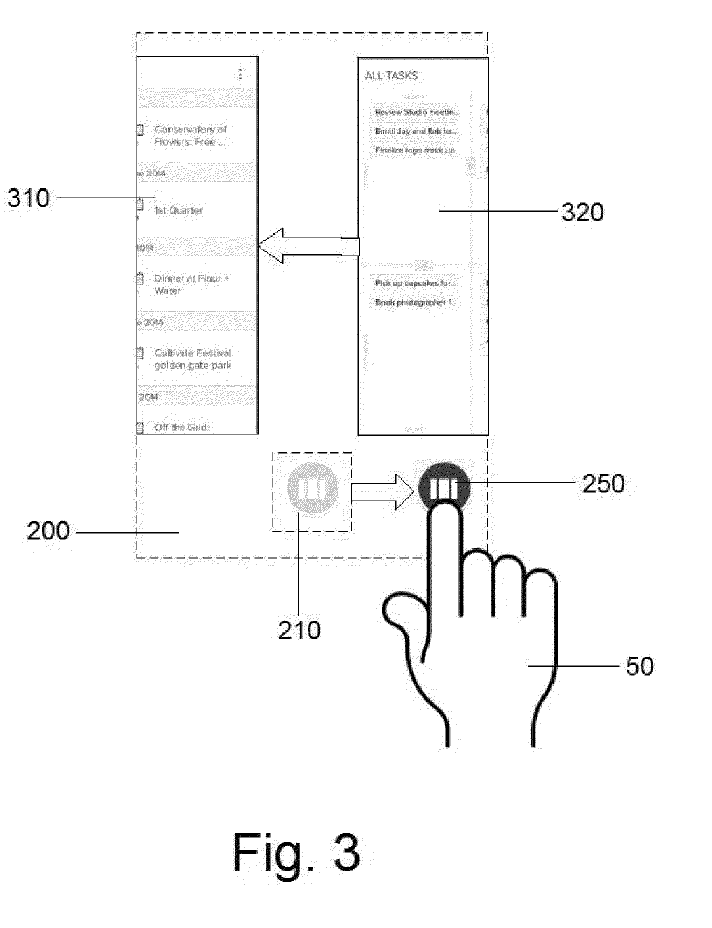

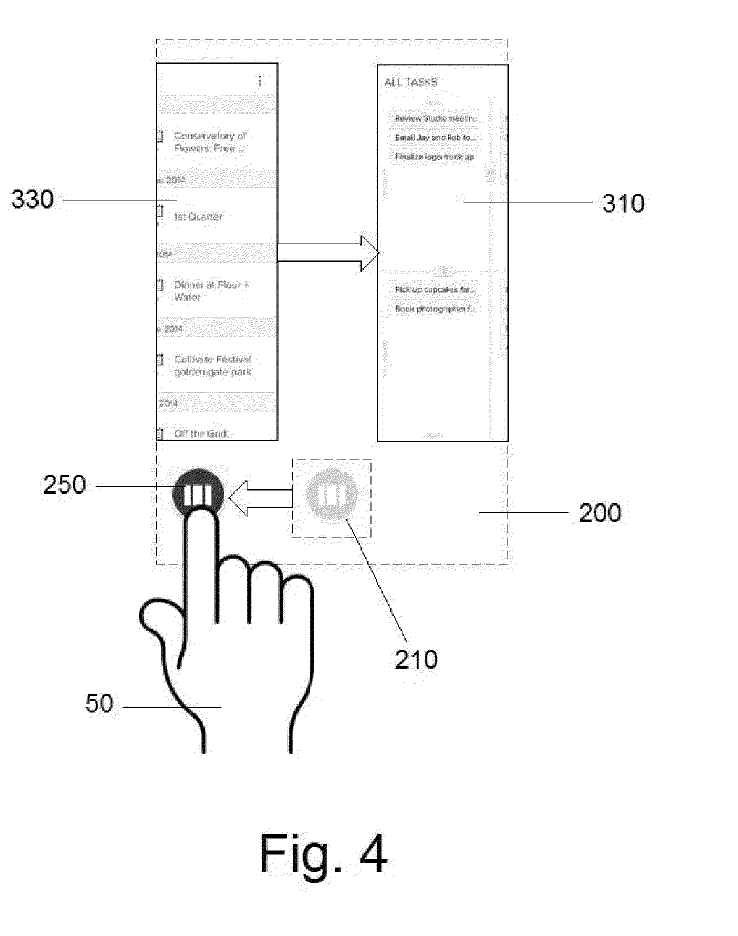

Referring to FIGS. 2-4, the use of the invention is displayed. At the beginning of the use of the invention the user 50 taps within the predetermined area 210 and touches the graphical image 250. The graphical image 250 tracks the space where the user 50 engages the touch screen interface 200. In the preferred embodiment the user 50 can move his finger laterally along the touch screen interface 200 to change the display of multiple panels. In other embodiments, the user may move his finger vertically or diagonally. In all embodiments the plurality of display panels scroll in the opposite direction than the direction swiped by the user 50. As shown in FIG. 3, as the user 50 taps and swipes to the right on the touch screen interface 200, the first display panel 310 originally displayed on the touch screen interface 200 slides to the left and is no longer displayed on the touch screen interface 200. At the same time a second display panel 320 slides to the left, becoming displayed on the touch screen interface 200 and replacing the first display panel 310. Alternatively, as shown in FIG. 4, the user may tap and swipe to the left. In response to the swipe to the left, the first display panel 310 slides to the right and is no longer displayed on the touch screen interface 200. At the same time a third display panel 330 slides onto the touch screen display from the left and replaces the first display panel 310.

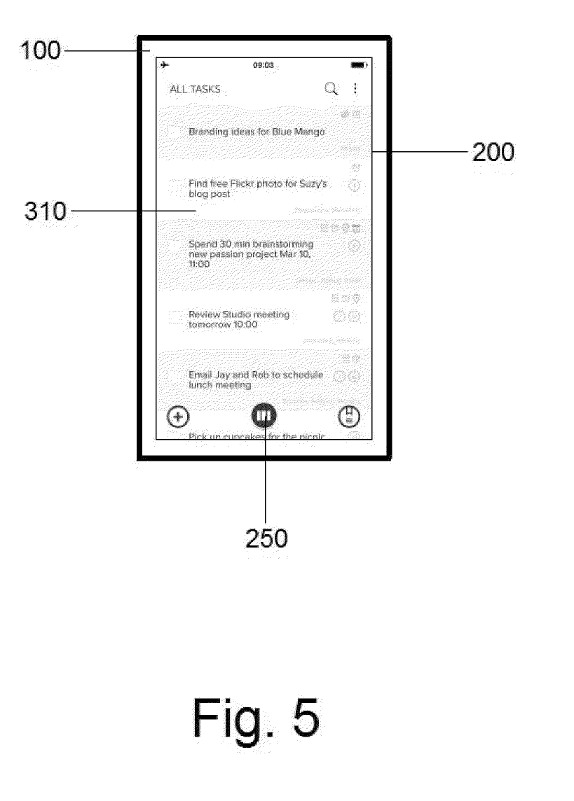

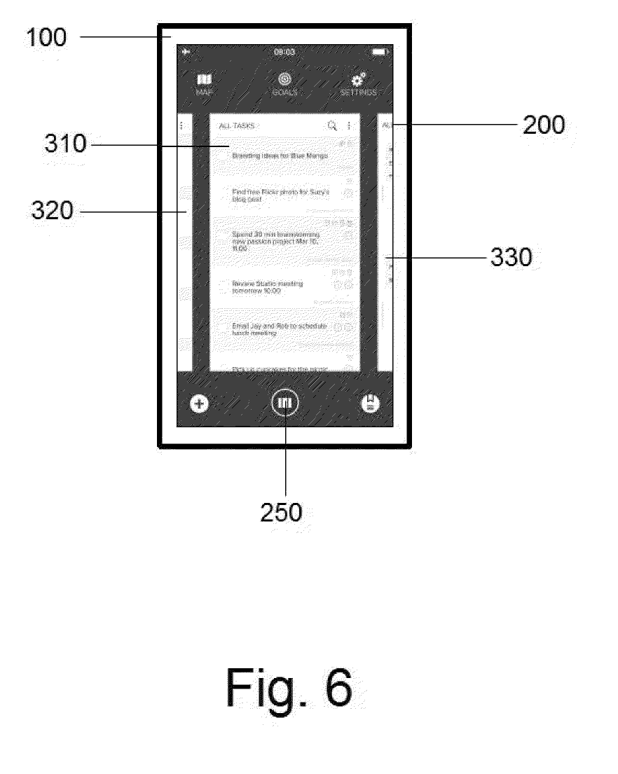

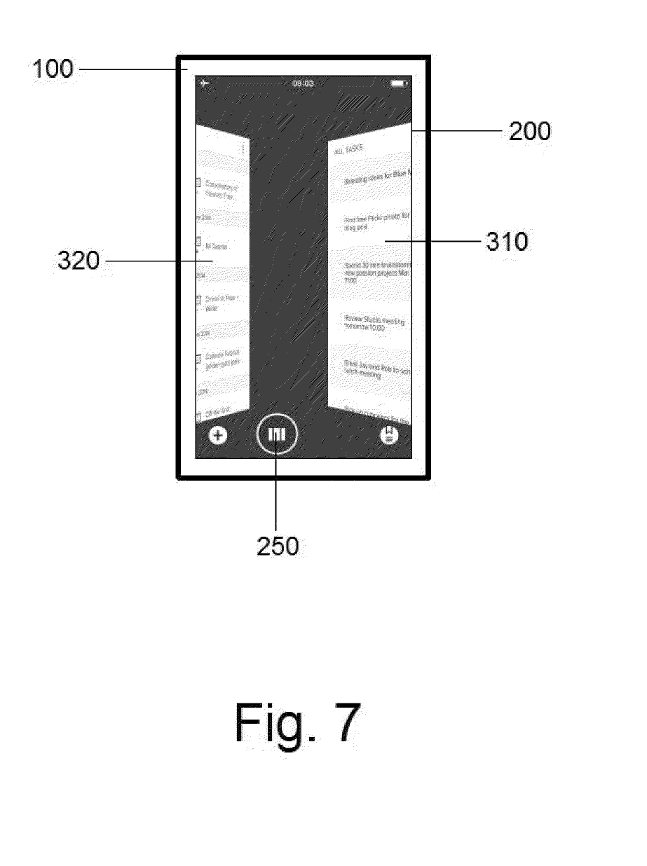

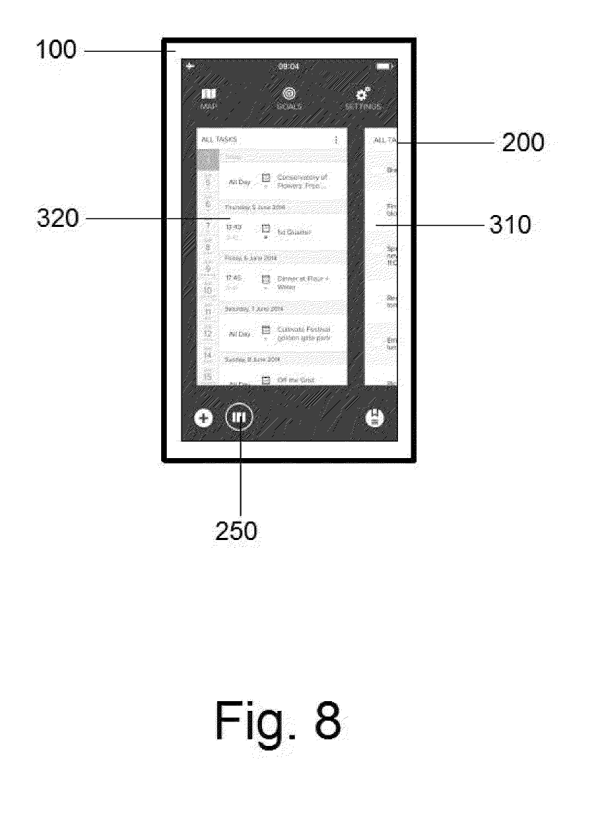

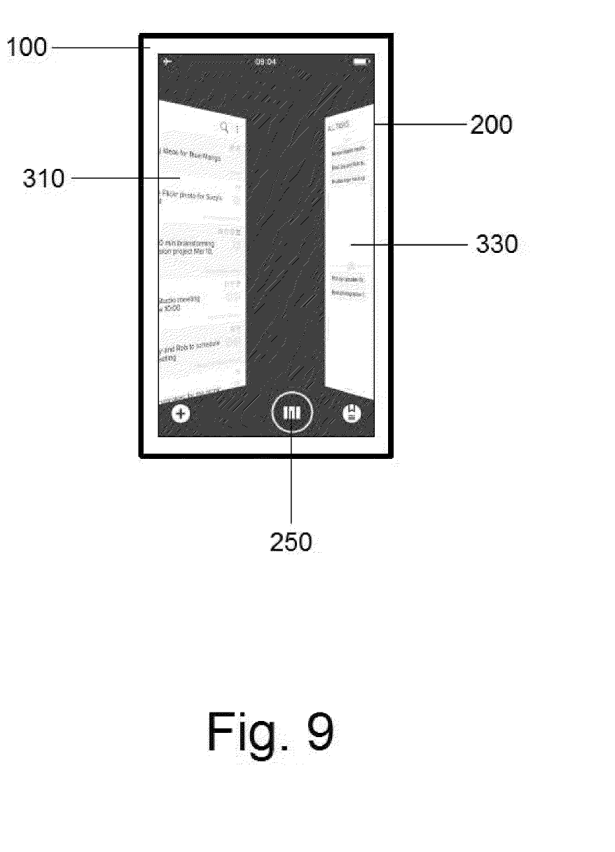

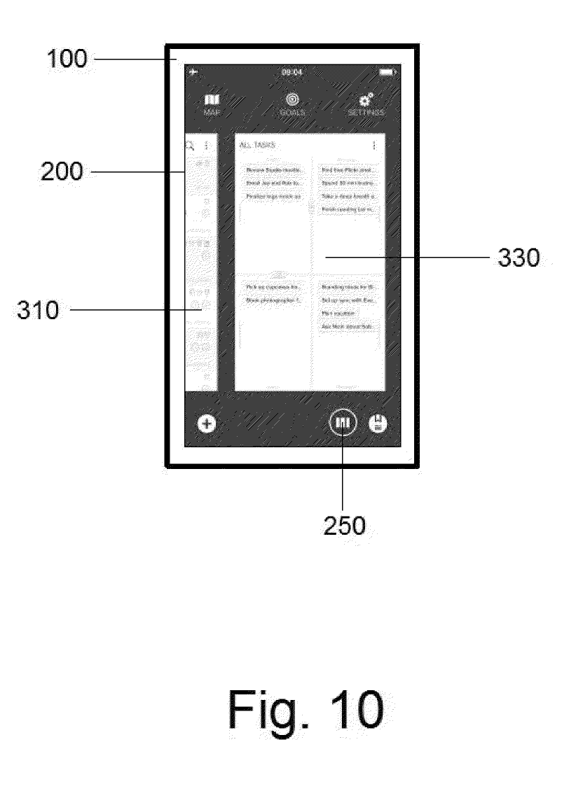

Referring to FIGS. 5-10, the use of the invention on an electronic device 100 is displayed. As shown in FIG. 5, the electronic device 100 is displaying a first display panel 310 on the touch screen display 200 with the graphical image 250. When a user first taps the graphical image 250, the touch screen display 200 provides a view of a plurality of display panels. As shown in FIG. 6, the first display panel 310, second display panel 320, and third display panel 330 are shown to a user. The user then drags the graphical image 250 in the direction of the desired display panel. As shown in FIGS. 7-8, if the user drags the graphical image 250 to the left, the first display panel 310 scrolls off of the touch screen display 200 to the right and the second display panel 320 comes onto the touch screen display 200 from the left. As shown in FIGS. 9-10, if the user drags the graphical image 250 to the right, the first display panel 310 scrolls off of the touch screen display 200 to the left and the third display panel 330 comes onto the touch screen display 200 from the right.

During the use of the invention, the user may scroll through multiple display panels. The display panels may contain any information. For instance the display panels may be pages on a handheld electronic device 100. Each page may show shortcut links to applications stored on the handheld electronic device 100. Alternatively, display panels may be open applications which are currently in use by the handheld electronic device 100.

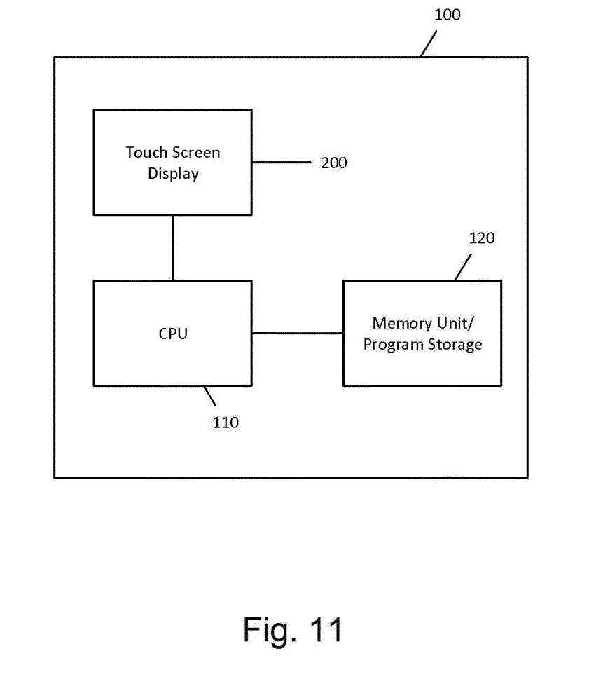

Referring to FIG. 11, a schematic of a standard electronic device 100 on which a user would use the invention. The electronic device 100 has a touch screen display 200 in connection with a CPU 110 and a nontransitory memory unit 120. The electronic device 100 may be any type of electronic device with a touch screen interface display, including, but not limited to, a cell phone, a tablet, a smart watch, a mobile computer, a wearable computer, or any other type of computer device with a touch screen interface.

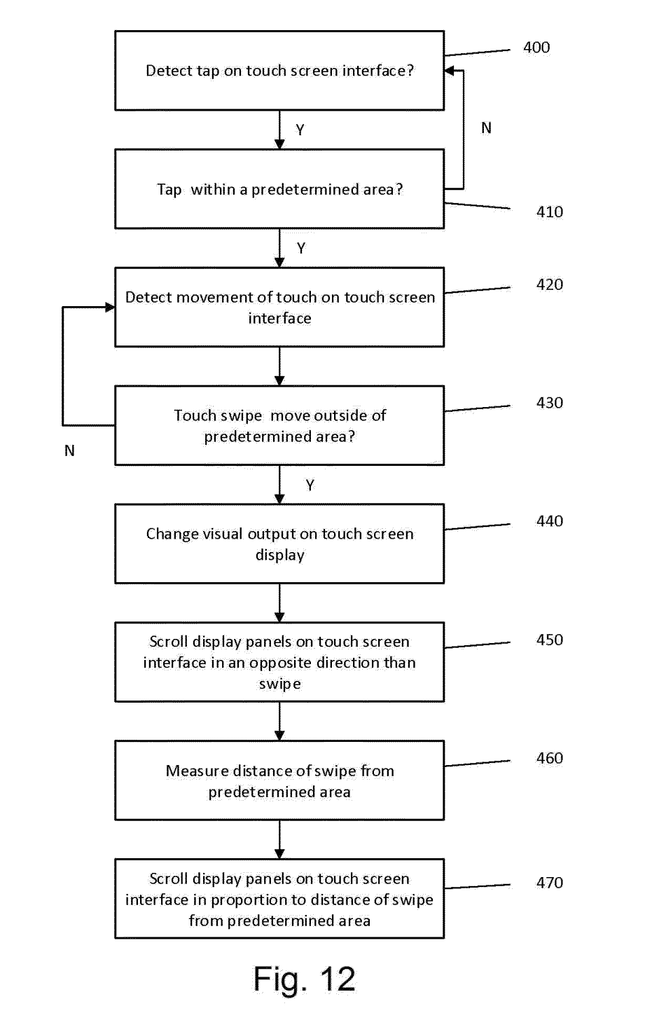

Referring to FIG. 12, the process of utilizing the invention is displayed. A user touches the touch screen display. The touch screen display detects the tap on the touch screen display 400. The electronic device determines whether the tap is within the predetermined area 410. If the tap is within the predetermined area the electronic device then detects the movement of the touch on the touch screen display 420. The electronic device then detects whether the touch swipe moves outside of the predetermined area 430. If the swipe goes outside of the predetermined area the electronic device then changes the visual output of the touch screen display 440. The electronic device then scrolls through the display panels on the touch screen display in the opposite direction than the swipe 450. The electronic device may measure the distance of the swipe from the predetermined area 460. The electronic device then scrolls through the display panels in proportion to the distance of the swipe from the predetermined area 470.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A computer system having a processor operatively coupled to a memory and a touch screen interface, the computer system being adapted to
Detect a tap on said touch screen interface within a predetermined area on said touch screen interface
Detect a swipe gesture across said touch screen interface
Said swipe gesture comprising an initial touchdown point within said predetermined area and a direction
Said swipe gesture terminating outside of said predetermined area
Perform a predetermined function changing the visual display output of said touch screen interface when said swipe gesture exceeds the boundaries of said predetermined area
Change the visual display output of said touch screen interface by moving a plurality of display panels across said touch screen interface in an opposite direction than the direction of said swipe gesture.

2. The computer system as in claim 1 wherein said computer system is further adapted to
Present a graphical image within said predetermined area on said touch screen interface
Present said graphical image on said touch screen interface during said swipe gesture
Present said graphical image along the path of said swipe gesture substantially simultaneous with said swipe gesture.

3. The computer system as in claim 1 wherein the computer system is a tablet computer.
